(19) United States
(12) Patent Application Publication
(10) Pub. No.: US 2014/0184515 A1
(43) Pub. Date: Jul. 3, 2014

(54) Thumb Keyboard for the Visually Impaired

(71) Applicant: Michael Willner, Lorton, VA (US)

(72) Inventor: Michael Willner, Lorton, VA (US)

(73) Assignee: AlphaGrip, Inc., Lorton, VA (US)

(21) Appl. No.: 14/085,956

(22) Filed: Nov. 21, 2013

Related U.S. Application Data
(60) Provisional application No. 61/729,669, filed on Nov. 26, 2012.

(51) Int. Cl. G06F 3/023

(52) U.S. Cl. CPC G06F 3/023
USPC 345/169

(57) ABSTRACT

A miniature keyboard optimized for use by older persons and the visually impaired is described. In order to quickly learn to use a miniature keyboard on a mobile phone, the present invention highlights a miniature keyboard's most frequently used characters for text messaging, including the alphabetical characters and the space. In a preferred embodiment of the present invention the alphabetical character keys and the space key are grouped together and distinguishable from the miniature keyboard's other keys by contrasting color or shade. In addition, to avoid confusion and clutter, and to maximize the size of the letters imprinted on the alphabetical keys, no other character is imprinted on the top surface of any alphabetical key. The group of alphabetical keys and the space key is symmetrically centered on the keyboard, making it easier to locate said keys and to reduce the risk of a repetitive strain injury.

### FIELD OF THE INVENTION

The present invention is generally related to a text entry device, and more specifically, it is an improved miniature keyboard optimized for use with the thumbs for handheld text entry on mobile phones. The present invention relates specifically to a physical keyboard as opposed to the on-screen keyboards incorporated into some mobile phones with touch-sensitive screens.

### BACKGROUND

Handheld information devices such as mobile phones have become indispensable to hundreds of millions of users throughout the world for purposes of communication and information consumption. One of the most popular uses of mobile phones is texting; the creation and wireless transmission of text messages by typing words and abbreviations on a keypad or miniature keyboard. The desire of many mobile phone users to increase the speed with which they create text messages has driven a constant and continuous evolution of input capabilities on mobile phones, including handwriting recognition and other stylus- or pen-based input systems, miniature keyboards, and software-based, onscreen keyboards.

Due to its tactile feedback and the availability of a sufficient number of keys to enable the generation of most, and in many cases all, major characters by pressing a single key with a single finger, the miniature keyboard is the input device of choice for many users interested in maximizing the speed and accuracy with which they can create a text message.

As the population ages, and baby boomers become elder boomers, the average age of mobile phone users is increasing. One of the most popular uses of mobile phones is text messaging. Additionally, with advances in technology, entering text into one's versatile mobile phone, also known as a smart phone, to search the internet for information or to enter addresses into mapping applications is also becoming common.

One problem with text entry on mobile phones is that many users, especially older ones who have been using physical keyboards for decades, are not comfortable using a phone with a virtual keyboard, i.e., a program that displays a graphical representation of a keyboard on the mobile phone's touch screen display, thus enabling users to enter text by pressing the virtual keys on the screen.

Another problem among older people is the impairment of their vision, which makes it more difficult for them to locate the letters on the small physical keyboards with monochromatic color schemes associated with mobile phones, which increases the length of time it takes visually impaired users to learn to type quickly and accurately.

Another problem with thumb keyboards designed for use with mobile phones, is that manufacturers must squeeze fewer keys on these relatively small keyboards than are on a standard keyboard for personal computers. Thus, in order to generate a sufficient number of characters, most of the keys must perform double or triple duty by generating additional functions, controls or characters when a user simultaneously presses a shift or function key with a key that generates an alphabetical character (hereinafter, an “alphabetical key”). To notify the user as to which additional characters a particular alphabetical key generates, additional graphics are imprinted on the keycaps, which often requires the manufacturer to reduce the size of the graphic for the alphabetical character so that all the characters on the key are discernable. This makes it more difficult for a user to locate a particular alphabetical key, especially during the early stages of learning to use a thumb keyboard. The additional graphics also create a cluttered appearance, thus adding to the difficulty of quickly locating a particular alphabetical key.

There have been several attempts to code keys on standard sized keyboards by color to enhance the learning process. An examplar is U.S. Pat. No. 5,700,097 to Kuhlenschmidt which attempts to simplify a child's learning process by associating different colors with different groups of characters determined by their input function, including an alphabetical key group, a numerical key group, the punctuation and text-editing key group, the programmable function group, and the cursor control key group. Such multi-colored key groupings are not practical, however, on a thumb keyboard, which has fewer keys than a standard keyboard and, therefore, combines two or more diverse functions on a single key. Functions, characters, controls, or commands from different functional key groupings often share the same key on a conventional miniature keyboard. Consequently, Kulhenschmidt's color groupings for a standard QWERTY keyboard, which would require individual keys on a miniature keyboard to be multi-colored, cannot be practically applied to the keys of a miniature keyboard.

Furthermore, the vast majority of miniature keyboards associated with mobile phones are merely smaller versions of the standard Qwerty keyboard, in which the letter keys are skewed to the left of the keyboard, with a number of less used punctuation marks taking up a significant portion of the right side of the keyboard. This results in a user employing the fingers of his left hand more frequently than those of his right hand. Thus, on a typical miniature thumb keyboard, the user uses his left thumb more frequently than his right, which can lead to a repetitive strain injury. Using the left thumb to generate more letters than the right, can also slow text entry relative to a key configuration that enables a user to activate approximately the same number of letters with each thumb. This is so because a user can press keys faster by alternating from one thumb to the other than by moving the same thumb to a different key.

The present invention is optimized for text messaging on mobile phones by older persons and the visually impaired. It enhances the learning process by enabling users to easily locate alphabetical characters and the space bar to generate text messages quickly and accurately on a thumb keyboard. The invention can also be employed with other computing devices that can benefit from handheld text entry such as home theater personal computers, remote controls, portable global positioning systems, music players, handheld computers, personal digital assistants, handheld gaming devices, and other handheld computing, communication, and control devices.

A preferred embodiment of the invention has large black or dark letters imprinted on white or light-colored keys, and no secondary characters associated with or imprinted on said keys, contrasted with all other non-alphabetical characters imprinted with white or light-colored characters on black or dark keys. The present invention's alphabetical keys are easy to find and activate, thus enabling the user to learn to type more quickly and accurately than he can on conventional thumb keyboards. These contrasting alphabetical keys enable users to learn to become proficient at generating text messages more quickly while also enabling the proficient user to enter text faster and more accurately. It is easier for the target audience to locate and recognize the alphabetical keys which are presented in shades or colors which sharply contrast with all other keys, where said alphabetical keys only depict one alphabetical character per key, and where no other characters are associated with said alphabetical keys. Therefore, it is one aspect of the invention to provide not only a miniature keyboard's alphabetical keys in sharply contrasting colors or shades, but to also provide such keys with no other characters associated therewith.

There is a wide variety of form factors which incorporate a miniature keyboard into a mobile phone. One of the more popular solutions involves placement of the keyboard beneath the phone's display where it remains “hidden” until such time as the user desires to enter text. A number of form factors have been devised to quickly and easily liberate the keyboard from its hidden, or “closed” position, to an exposed “open” position. One of the earlier solutions included the use of one or more hinges connecting the display to the keyboard enabling it to open and close like a “clam shell.” One drawback to this solution, however, is that the keyboard and the display are unavailable when the device is in a closed position. An alternative solution which has the display exposed even when the phone is “closed” and the keyboard is hidden, involves a sliding mechanism which enables a user to move the display “up” and “away” from the keyboard using a sliding motion. A preferred embodiment of the present invention incorporates the thumb keyboard described herein, slidably connected to the body of a mobile phone, though different connecting mechanisms may be used in alternative embodiments of the present invention.

Some of the most popular mobile phones, such as the iPhone, have no physical keyboard. To address the concerns of users who prefer to use a physical keyboard with such keyboard-less mobile phones, a preferred embodiment of the present invention provides the thumb keyboard described herein, incorporated into a case with a sliding mechanism. This combination case and keyboard enables a user to insert his phone into the case leaving the display exposed, while the keyboard is “hidden” beneath the case. To access the physical keyboard, a user can slide the case, along with the phone that is inserted therein, up and away from the keyboard housing, revealing the physical keyboard. In other embodiments of the present invention, different mechanisms can be used to connect the thumb keyboard with the case. Some of these keyboard-less mobile phones are so narrow, however, that cases designed to hold the phone snuggly are not wide enough to cover a thumb keyboard with large keys for fast accurate texting, such as those incorporated into the present invention. One embodiment of the present invention, therefore, is a combination case and keyboard where the case has an extension which makes it wide enough to cover the whole keyboard housing.

### SUMMARY

A preferred embodiment of the present invention is a thumb keyboard with a Qwerty letter layout optimized for text messaging by the visually impaired, and is especially applicable to mobile phones, though it can be used for other computing devices such as home theater personal computers, remote controls, portable global positioning systems, music players, handheld computers, personal digital assistants, and handheld gaming devices. It enables users to quickly learn to use a thumb keyboard with a Qwerty letter layout for fast and accurate text entry. Other embodiments of the invention can incorporate different letter layouts without diminishing the invention's unique ability to enhance the learning process for text messaging by older persons and the visually impaired.

The alphabetical character keys of the thumb keyboard in a preferred embodiment of the present invention are white with large black letters centered thereon, contrasting with, and standing out from, the rest of the keyboard's non-letter keys which are black with multiple, smaller non-letter characters imprinted thereon. In another embodiment, the shades can be reversed, i.e., white alphabetical characters on black keys, and all other characters on white keys. By utilizing just the two shades most associated with thumb keyboards, white and black, to only separate the alphabetical character keys and space bar from all the other keys, the present invention simplifies the learning process for text messaging on a thumb keyboard. Over time, the minimalist black and white key coding of the present invention is less distracting and mentally tiresome than it would be with multi-colored keys. In addition, where a thumb keyboard has fewer keys than a standard keyboard and, therefore, the keys must generate multiple characters, establishing various multiple key groupings based on color coding such as those described in U.S. Pat. No. 5,700,097 to Kuhlenschmidt, is difficult and impractical, at best. Moreover, in the age of texting with minimal punctuation, the alphabetical character keys plus the space bar are significantly more important than a thumb keyboard's other keys. Thus, the learning process for text messaging is further simplified by emphasizing the one major key group above all others.

In a preferred embodiment of the present invention, the alphabetical character keys generate no other characters and the top surface of each key displays no other graphic of any other character—only the alphabetical character associated therewith. The absence of graphical representations of other characters eliminates the cluttered look of the typical thumb keyboard key thereby simplifying the learning process by making it easier to locate a particular alphabetical key.

In an implementation of the present invention, the alphabetical character group plus the space bar are symmetrically centered on the keyboard, with the same number of alphabetical characters accessible by each thumb as is the space bar. This is an improvement over the typical skewing of alphabetical keys to the left on a standard Qwerty keyboard because it reduces the risk of developing a repetitive strain injury by overtaxing the user's left thumb. The symmetrical orientation also increases text entry speed by evenly spreading the work of key pressing over both thumbs of a user.

In a second preferred embodiment of the present invention, the improved thumb keyboard described herein is incorporated into a housing that is slidably connected to a case for a mobile phone. In an initial configuration the case is closed, such that it covers substantially all of the keyboard housing while the display of the mobile phone that is held in the case remains viewable and accessible by a user. In addition, the plane of the case's bottom surface is parallel to the plane of the keyboard housing's bottom surface. In a second configuration the case is open, where it has slid up and away from the keyboard housing such that the bottom plane of the case is on the same parallel plane that it was on relative to the keyboard housing when the case was closed. In addition, the top surface area of the keyboard housing, which is substantially composed of the thumb keyboard described herein, is completely exposed and accessible by a user.

The case and keyboard housings are connected to each other via a sliding module, which consists of a sliding mechanism and a guiding structure. The sliding mechanism and the guiding structure, the well-known functionality and various constructions of which are commonly understood by those of ordinary skill in the art, are composed of several parts, which are disposed beneath the bottom surface of the case and on the top portion of the outer surface of the keyboard housing above the thumb keyboard.

As a user puts upward pressure on the case, the sliding module that connects the case to the keyboard housing enables the case to move up relative to the keyboard housing, until the case clears the top edge of the top row of keys on the keyboard so that the keyboard is completely exposed and accessible by a user. A user holds the case by its second housing, which indirectly supports the weight of the mobile phone enclosed in the case.

In a further implementation of the present invention, the keyboard housing is directly connected to the main body of a mobile phone and is, therefore, an integral part of the mobile phone itself.

This Summary is provided to introduce a selection of concepts in a simplified form that are further described below in the Detailed Description. This Summary is not intended to exclusively or comprehensively identify key features or essential features of the claimed subject matter, nor is it intended to be used as the sole description of the present invention in determining the scope of the claimed subject matter.

### BRIEF DESCRIPTION OF THE DRAWINGS

The above and other objects, features, and advantages of certain examplary embodiments of the present invention will be more apparent from the following description taken in conjunction with the accompanying drawings, in which:

FIG. 1a is a plan view of a conventional thumb keyboard with a Qwerty letter layout.

FIG. 1b is a plan view of a conventional thumb keyboard with a base member of a conventional sliding device attached to the upper end of the top surface above the keys.

FIG. 2a is a plan view of a conventional case for a mobile phone.

FIG. 2b is a plan view of a sliding member of a conventional sliding device.

FIG. 3a is a diagram which shows how a mobile phone slides and fits snugly into a conventional case.

FIG. 3b is a plan view of a conventional combination sliding case and thumb keyboard in an opened position.

FIG. 4a is a plan view of a preferred embodiment of the present invention depicting an improved thumb keyboard.

FIG. 4b is a perspective view of the preferred thumb keyboard with a base member of a sliding device attached to the upper end of the top surface above the keys.

FIG. 5a is plan view of a preferred embodiment of the present invention depicting an improved combination case and keyboard for a mobile phone in a closed position.

FIG. 5b is a perspective view of the improved combination case and keyboard for a mobile phone in a closed position.

FIG. 6a is a diagram which shows how a mobile phone slides and fits snugly into the improved combination case and keyboard in a closed position.

FIG. 6b is a perspective view of a sliding member of a sliding device for the improved combination case and keyboard for a mobile phone.

FIG. 7a is a longitudinal sectional view of the improved combination case and thumb keyboard in a closed position.

FIG. 7b is a longitudinal sectional view of the improved combination case and thumb keyboard after the case has been slid open to reveal the improved thumb keyboard.

FIG. 8 is a plan view of the improved combination case and keyboard after the case is slid open to reveal the improved thumb keyboard.

FIG. 9 is a plan view of the improved combination case and keyboard for a mobile phone beside a conventional case and keyboard for a mobile phone.

Throughout the drawings, the same reference numerals will be understood to refer to the same elements, features and structures.

### DETAILED DESCRIPTION OF THE INVENTION

The matters defined in the description such as a detailed characteristics and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Hereinafter, exemplary embodiments of the present invention will be described in detail with reference to the accompanying drawings.

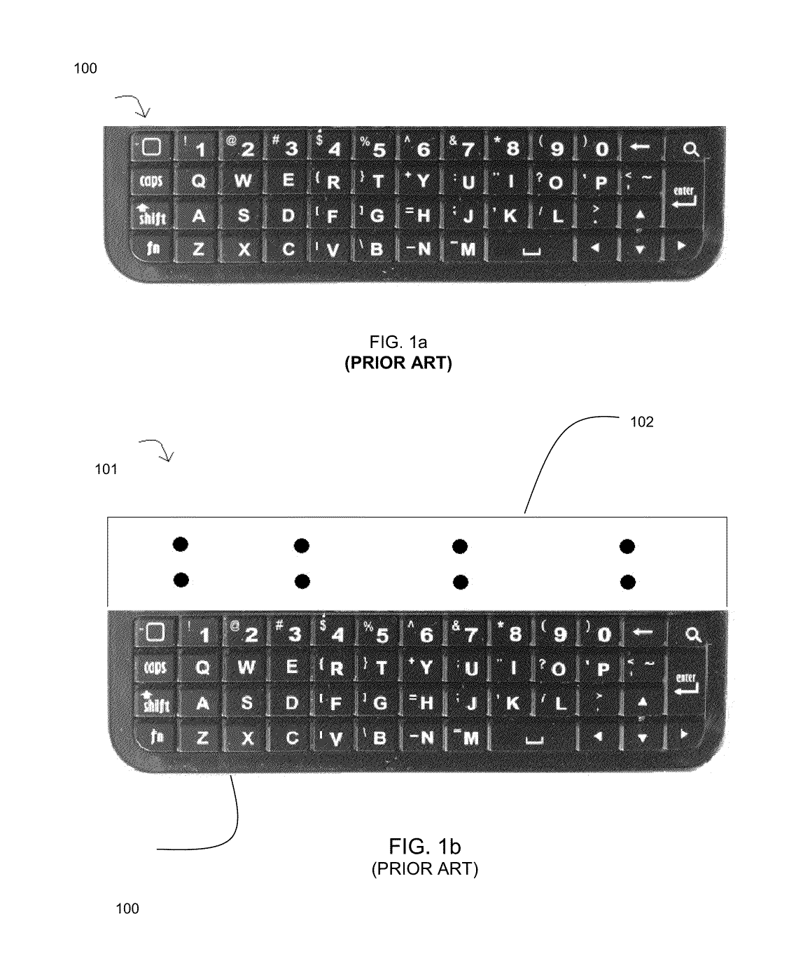

FIG. 1a shows a conventional thumb keyboard 100. It has all black keys with primarily white characters, a Qwerty letter layout, several alphabetical keys have an additional character imprinted beside the letter, the alphabetical keys as a group are skewed toward the left of the keyboard, and the keys are relatively small.

FIG. 1b shows an embodiment of the conventional thumb keyboard 100, which includes the base member 102 of a sliding device, the form and details of which are well understood by those skilled in the art.

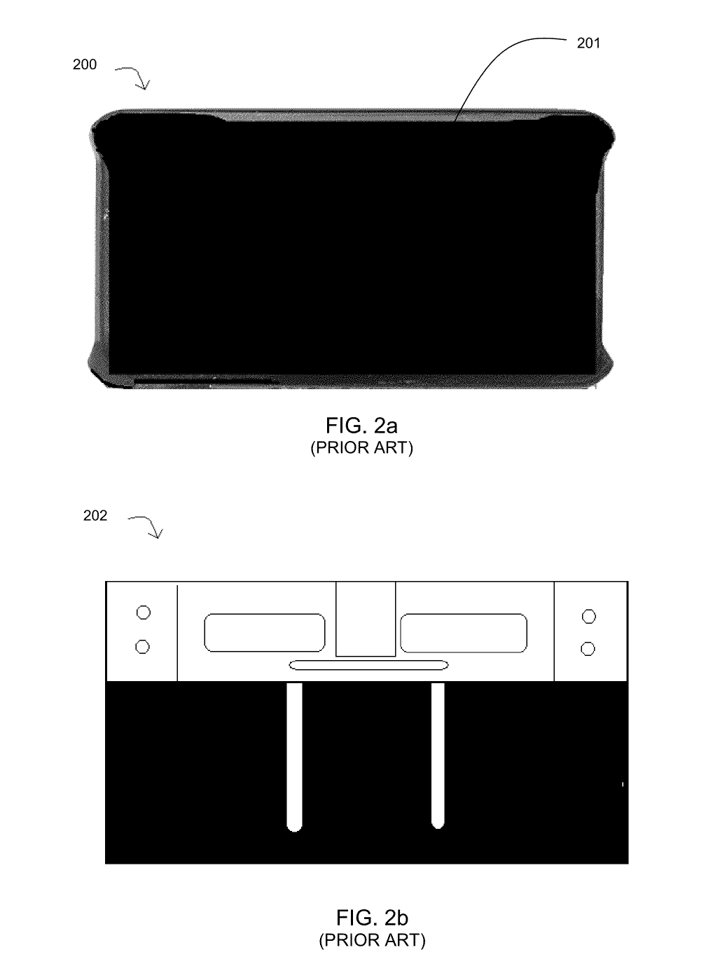

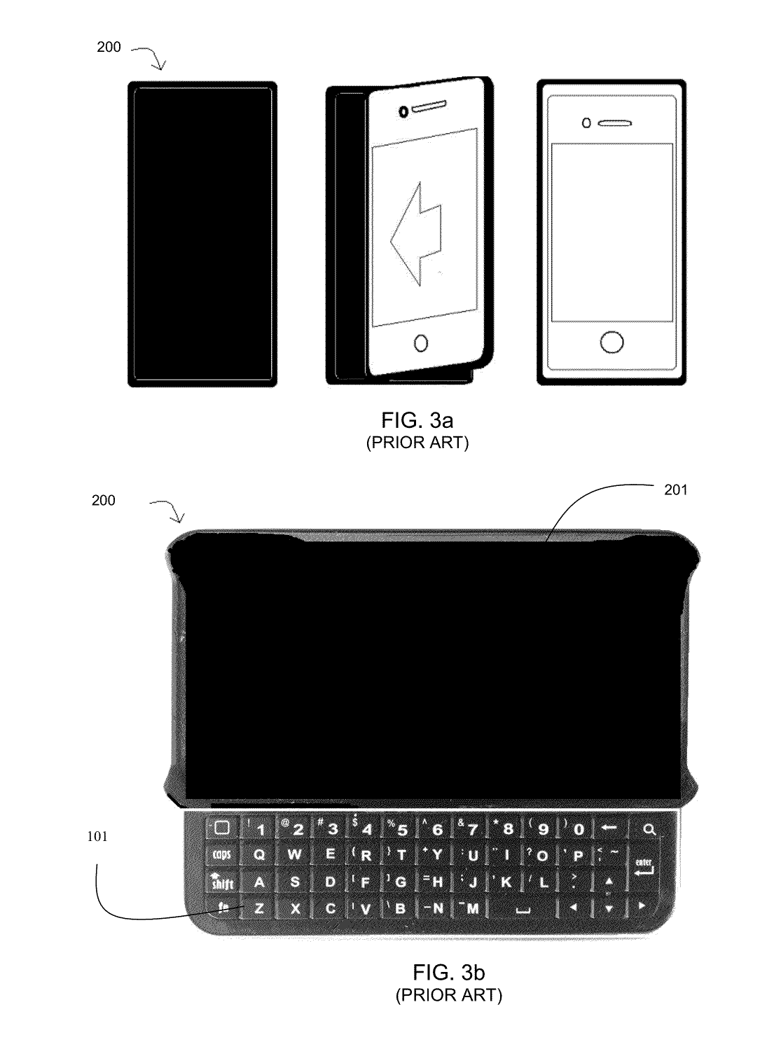

FIG. 2a is a plan view of an exemplary embodiment of a conventional sliding case and keyboard 200 for a popular mobile phone, the iPhone, in a closed position. The conventional thumb keyboard with base member 101 in FIG. 1b is completely hidden beneath the case. The keyboard 101 slidably connects to the case 201 in FIG. 2a via the sliding member 202 in FIG. 2b, which is attached to the underside of the case 201 in FIG. 2a. The case 201 is approximately 62 millimeters wide, designed to allow the iPhone to fit in snugly as shown in FIG. 3a.

In FIG. 3b the keyboard portion of the conventional keyboard housing and base member 101 is exposed after sliding out from under the case 201, while the base member remains hidden beneath and indirectly connected to the case 201 by means of the sliding member 202.

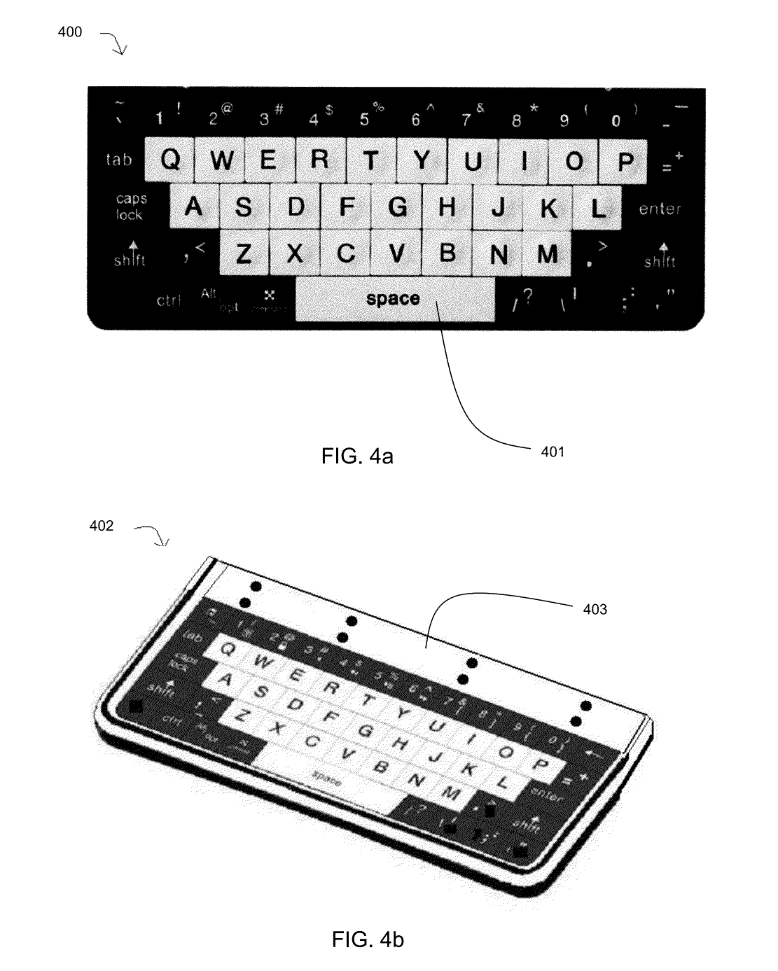

As shown in FIG. 4a, the improved thumb keyboard 400 has the alphabetical keys and space bar grouped together 401 (hereinafter, the “text messaging group”), which is especially helpful for a thumb keyboard because the most prevalent use of same is for generating text messages (hereinafter “texting”), and the most commonly used characters in text messages are letters and the space.

The text messaging group is visually set off from all the other keys of the improved thumb keyboard 400 by reverse shading. Thus, in the exemplary embodiment shown in FIG. 4a the group's keys are white, while the graphics on the top surface are black. By contrast, all other keys on the thumb keyboard are black with primarily white graphics on their top surface. The contrasting shades help visually impaired individuals, especially those who are colorblind, locate and discriminate between the text messaging group 401 and the rest of the keys on the present invention. While contrasting shades of various colors can substitute for the white and black keys and graphics in other embodiments of the present invention, the sharp contrast of white versus black is optimum for color blind users.

The ability of the visually impaired to quickly discriminate between the text messaging group 401 and the rest of the keys of the exemplary embodiment of the present invention 400 in FIG. 4a, is further enhanced by restricting the graphics imprinted thereon to only one alphabetical character per key. By eliminating potentially distracting and confusing graphics of other characters from the alphabetical keys of the present invention, which are typically found on the alphabetical keys of conventional thumb keyboards, the visually impaired can locate the desired alphabetical characters more quickly and efficiently.

A further enhancement found in the improved thumb keyboard 400, is the symmetrically centered placement of the text messaging group 401. The typical thumb keyboard with a Qwerty letter layout, such as that shown in FIG. 1a, has the group of alphabetical keys skewed to the left of the keyboard. Where a thumb keyboard is primarily used to generate text messages and the most commonly activated characters are alphabetical and space, the conventional thumb keyboard 100 requires a user to use his left thumb more often than his right thumb, which can increase the risk of developing a repetitive strain injury (RSI), while slowing one's texting capabilities. The present invention reduces the risk of developing an RSI while increasing texting speed, by symmetrically centering the text messaging group 401 within the keyboard, thereby enabling a user to activate the same number of alphabetical characters with each thumb. A user will type faster when generating characters by alternating key presses between thumbs as opposed to using the same thumb to move from one key to another.

The incorporation of the improved thumb keyboard 400 into a case for a mobile phone according to a second exemplary embodiment of the present invention will now be described in detail with reference to FIGS. 4a, 4b, 5a, 5b, 6a, 6b, 7a, 7b, 8, and 9.

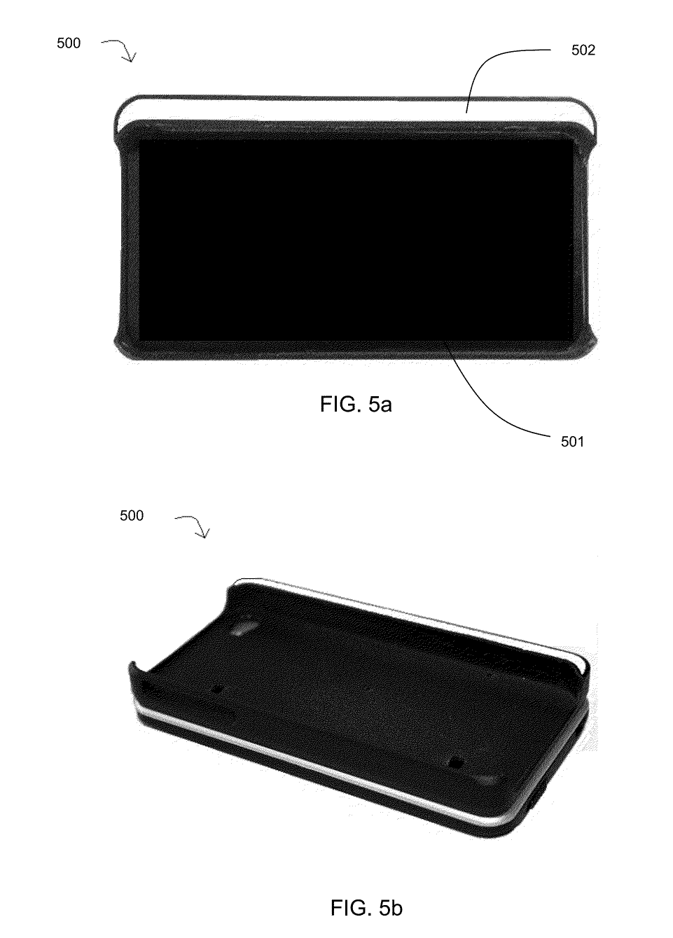

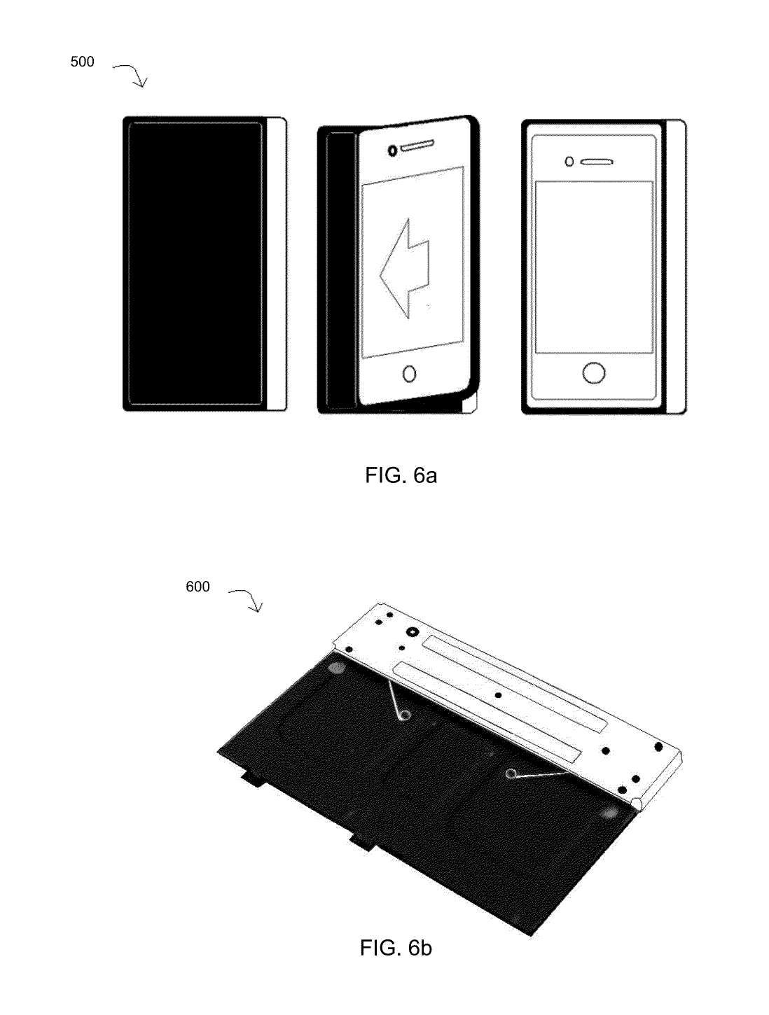

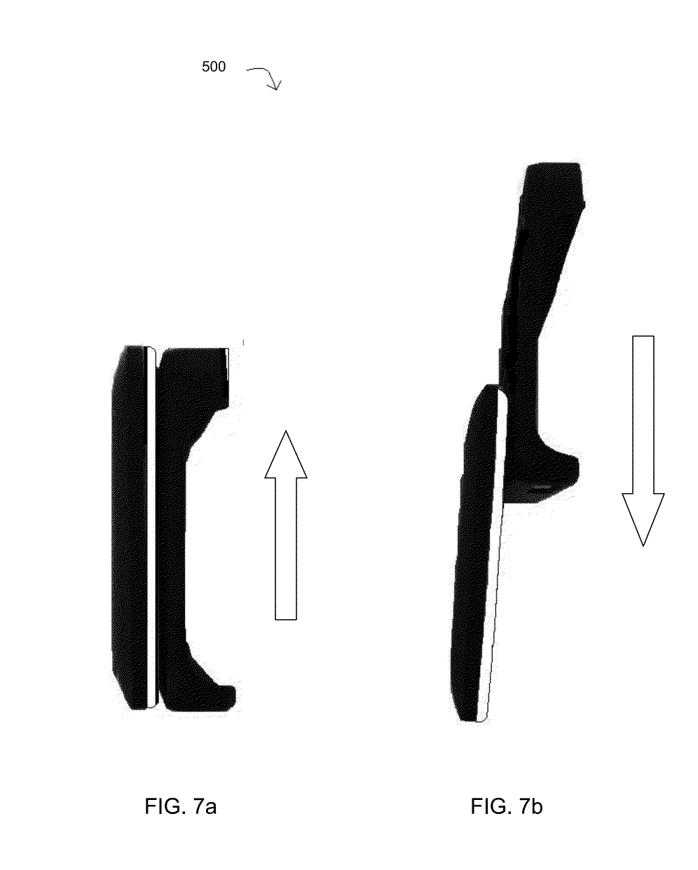

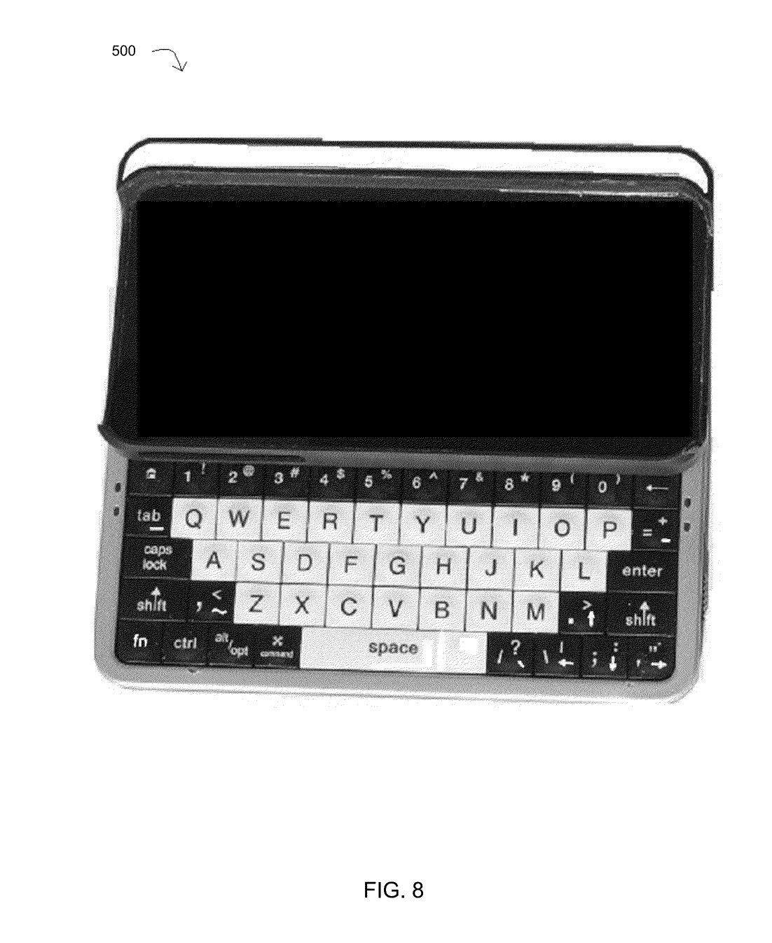

FIG. 4b shows an exemplary embodiment of the improved thumb keyboard 400 incorporated into a keyboard housing 402 which includes a base member 403 of a sliding device located above the keyboard on the top surface of the keyboard housing. The base member 403 slidably connects to a sliding member of a sliding device 600 in FIG. 6b, which is attached to the underside of an improved combination case and keyboard 500 depicted in a closed position in FIGS. 5a and 7a, and in an opened position in FIGS. 7b and 8. The sliding device employed in the exemplary embodiment of an improved combination case and keyboard 500 is well understood by those of ordinary skill in the art. In alternative embodiments of the present invention, the housing for the improved thumb keyboard can be attached to a case by various means, including, but not limited to, hinges, which are also well understood by those of ordinary skill in the art.

FIGS. 5a and 5b show an exemplary embodiment of a combination case and improved thumb keyboard 500, in which an improved case 501 has an extension 502, which makes the outer dimensions of the case wider than the mobile phone that fits into it snugly as depicted in FIG. 6a. The inner dimensions of the improved case 501 snugly accommodate a smartphone that is narrower than the case's outer dimensions. A wider case allows a wider keyboard housing such as that of the improved thumb keyboard 402 to be attached thereto and completely hidden from sight when the improved combination case and keyboard 500 is closed. A wider keyboard housing 402 accommodates larger keys for faster more accurate texting by older persons and the visually impaired relative to the conventional thumb keyboard 100 incorporated into the relatively narrow conventional keyboard housing 101. Thus, relatively narrow mobile phones such as the iPhone can be equipped with the larger improved thumb keyboard 400 when it is incorporated into an improved combination case and keyboard 500. The wider case covers the whole keyboard when the case is closed, thereby avoiding accidental key presses when the mobile phone is not in use.

The base member 403 attached to the keyboard housing 402 of the present invention 400 is connected to the relatively wide sliding member 600 depicted in FIG. 6b, which in turn is attached to the back side of the improved case 501 in FIG. 5a. FIG. 7a shows a longitudinal sectional view of the improved case and keyboard 500 in a closed configuration. FIG. 7b shows a longitudinal sectional view of the improved case and keyboard 500 after the improved case 501 is slid open.

FIG. 8 shows a plan view of the second preferred embodiment of the present invention, the improved combination case and keyboard for a mobile phone 500 after the relatively wide case 501 is slid up to reveal the improved thumb keyboard 400. FIG.

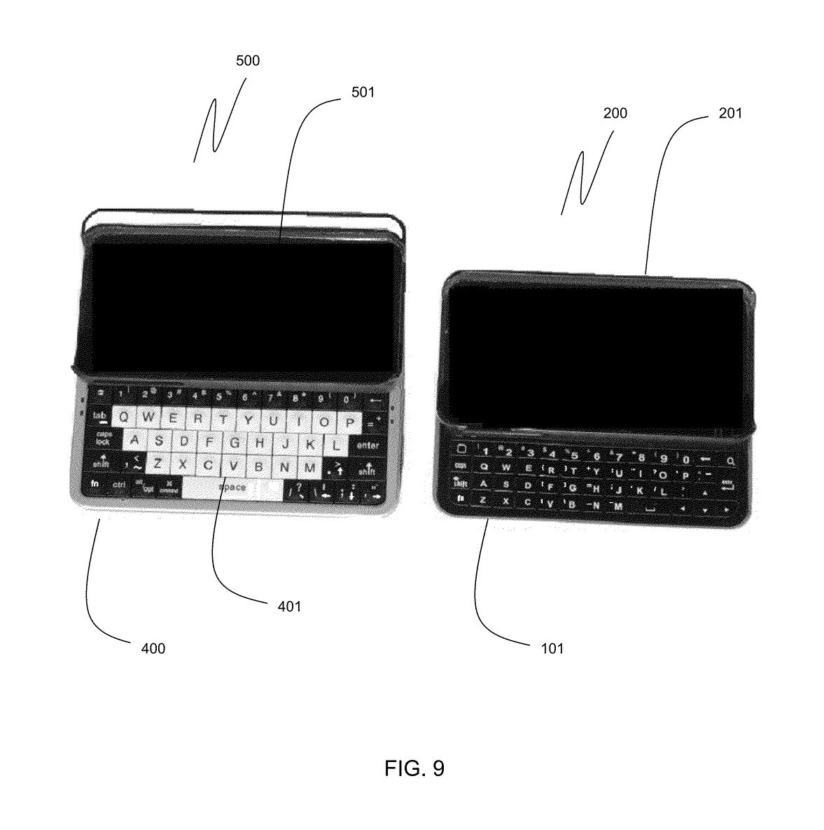

FIG. 9 is a plan view of the improved combination case and keyboard 500 beside the conventional case and keyboard 200. It is obvious to the reader that the improved thumb keyboard 400 is larger than the conventional thumb keyboard 100 and that the alphabetical characters and space of the text messaging group 401 are significantly more visible and, therefore, easier to locate than the alphabetical characters imprinted on the monochrome keys of the conventional thumb keyboard 101. The alphabetical characters stand out because they are associated with keys that are larger than those on the conventional thumb keyboard 101, they do not share the keycaps with any other characters, they are imprinted on white keys that sharply contrast with all the other black keys, and they are centered on the keyboard. Consequently, a user of the improved combination case and keyboard 500 with impaired vision would be able to readily locate the desired alphabetical characters and space and, therefore, will be able to learn to use the keyboard faster than the conventional thumb keyboard 101 incorporated into the conventional combination case and keyboard 200 designed for a relatively narrow mobile phone such as the iPhone. In addition, once a visually impaired user who has the improved combination case and keyboard 500 learns to use the improved thumb keyboard 400 incorporated therein, he will be able to text faster, more accurately and more ergonomically as compared to texting on the conventional thumb keyboard 101.

While the invention has been shown and described with reference to certain exemplary embodiments thereof, it will be well understood by those skilled in the art that various changes in form and details may be made therein without departing from the spirit and scope of the invention as defined by the appended claims.

What is claimed is:

1. A miniature keyboard comprising:
a plurality of keys for inputting data to an electronic device;
said keys generate at least the letters of the alphabet, space, and numbers 1, 2, 3, 4, 5, 6, 7, 8, 9 and 0; and
the alphabetical character keys and space key are grouped together by a single color or shade, which is different than the color or shade of all other keys on the keyboard.

2. The miniature keyboard of claim 1, wherein the alphabetical character keys have only one alphabetical character printed on the top surface of each key.

3. The miniature keyboard of claim 1, wherein the non-alphabetical character keys have the same color or shade as each other.

4. The miniature keyboard of claim 1, wherein the group of alphabetical character keys and space key is symmetrically centered on the keyboard.

5. The miniature keyboard of claim 1, wherein the group of alphabetical character keys is arranged in substantially a QWERTY letter layout.

6. The miniature keyboard of claim 1 wherein:
the group of alphabetical character keys and the space key are white or a shade of white with black or a shade of black characters printed thereon, and all the other keys are black or a shade of black with white or a shade of white characters printed thereon; or
the group of alphabetical character keys and the space key are black or a shade of black with white or a shade of white characters printed thereon, and all the other keys are white or a shade of white with black or a shade of black characters printed thereon.

7. The miniature keyboard of claim 1, attached to a case for a mobile phone wherein:
said case incorporates an extension which causes the outside dimensions of said case to be wider than the dimensions of said mobile phone;
the inside dimensions of said case are narrower than the outside dimensions;
said mobile phone fits snugly inside said case; and
said case completely covers the housing for said miniature keyboard when said case is in a closed position.

8. The miniature keyboard of claim 1, incorporated into a mobile phone.

9. A miniature keyboard comprising:
a plurality of keys for inputting data to an electronic device;
said keys generate at least the letters of the alphabet, space, and numbers 1, 2, 3, 4, 5, 6, 7, 8, 9 and 0;
the alphabetical character keys are grouped together by a single color or shade, which is different than the color or shade of all other keys on the keyboard;
the alphabetical character keys have only one alphabetical character printed on the top surface of each key;
the non-alphabetical character keys have the same color or shade as each other;
the group of alphabetical character keys and space key is symmetrically centered on the keyboard; and
the group of alphabetical character keys is arranged in substantially a QWERTY letter layout.

10. The miniature keyboard of claim 9 wherein:
the group of alphabetical character keys and the space key are white with black characters printed thereon, and all the other keys are black with white characters printed thereon; or
the group of alphabetical character keys and the space key are black with white characters printed thereon, and all the other keys are white with black characters printed thereon.

11. The miniature keyboard of claim 9, attached to a case for a mobile phone wherein:
said case incorporates an extension which causes the outside dimensions of said case to be wider than the dimensions of said mobile phone;
the inside dimensions of said case are narrower than the outside dimensions, said mobile phone fits snugly inside said case; and
said case substantially covers the housing for said miniature keyboard when said case is in a closed position.

12. The miniature keyboard of claim 10, attached to a case for a mobile phone wherein:
said case incorporates an extension which causes the outside dimensions of said case to be wider than the dimensions of said mobile phone;
the inside dimensions of said case are narrower than the outside dimensions, said mobile phone fits snugly inside said case; and
said case substantially covers the housing for said miniature keyboard when said case is in a closed position.
